(19) United States
(12) Patent Application Publication
(10) Pub. No.: US 2016/0314421 A1
(43) Pub. Date: Oct. 27, 2016

(54) Market-Driven Mining Optimization

(71) Applicant: Caterpillar Inc., Peoria, IL (US)

(72) Inventor: Craig Watkins, Peoria, IL (US)

(73) Assignee: Caterpillar Inc., Peoria, IL (US)

(21) Appl. No.: 14/696,541

(22) Filed: Apr. 27, 2015

(51) Int. Cl. G06Q 10/06; G06Q 30/02; G06Q 10/08

(52) U.S. Cl. CPC G06Q 10/06313; G06Q 10/08345; G06Q 10/08355; G06Q 30/0206

(57) ABSTRACT

Systems and methods for market-driven mining operation optimization are disclosed. One method includes receiving first data including one or more of a mining operation model and information relating to operation of a mining operation, wherein the mining operation model comprises a simulated operation of a mine site associated with the mining operation. The method further includes receiving second data, the second data including market data associated with a material produced by the mining operation. An optimization plan is determined based on the first data and the second data, the optimization plan including an identification of an operational aspect of the mining operation to be modified or implemented. An instruction is then generated based at least on the determined optimization plan.

### TECHNICAL FIELD

This disclosure relates generally to management of mining operations, and more particularly to a system and method for market-driven mining optimization.

### BACKGROUND

A large-scale mining operation may typically involve multiple mine sites distributed across a broad geographical region and producing a variety of ores and other materials. Management of such a mining operation may include managing the small-scale operations at each of the mine sites as well as the enterprise-level operations of the mining operation, such as coordination of mine site productions and the delivery of produced materials to customer delivery sites.

One method for managing the operations of a single mine site is described in U.S. Pat. No. 8,504,505 (“the '505 patent”). The '505 allegedly describes a system and method for optimizing an index of an autonomous worksite including a plurality of autonomous trucks. The optimization is based on several factors, including economic market information and local worksite operational data relating to the autonomous trucks.

Although the '505 patent describes a system and method of optimizing a single worksite with autonomous trucks, the system and method are unsuitable for managing and optimizing an enterprise-level mining operation. The system and method described in the '505 patent are also unsuitable for variable term planning. These and other shortcomings of the prior art are addressed by this disclosure.

### SUMMARY

This disclosure relates to systems and methods for market-driven mining optimization. In an aspect, a method may comprise: receiving, via one or more computing devices, first data comprising information relating to an extraction of material at one or more mine sites and a transport of the material to one or more delivery sites external to the one or more mine sites; receiving, via one or more computing devices, second data comprising market data relating to the material, the market data comprising a quantity of the material; determining, via one or more computing devices, an optimization plan based at least on the first data and the second data, the optimization plan comprising a modification to at least one of the extraction of the material at one or more mine sites and the transport of the material to one or more delivery sites; and generating, via one or more computing devices, an instruction based at least on the determined optimization plan comprising a modification to at least one of the following: the extraction of the material at one or more mine sites and the transport of the material to one or more delivery sites.

In an aspect, a system may comprise a processor; and a memory bearing instructions that, upon execution by the processor, cause the system at least to: receive first data comprising information relating to an extraction of material at one or more mine sites and a transport of the material to one or more delivery sites external to the one or more mine sites; receive second data comprising market data relating to the material, the market data comprising a quantity of the material; determine an optimization plan based at least on the first data and the second data, the optimization plan comprising a modification to at least one of the extraction of the material at one or more mine sites and the transport of the material to one or more delivery sites; and generate, based at least on the determined optimization plan, an instruction comprising a modification to at least one of the extraction of the material at one or more mine sites and the transport of the material to one or more delivery sites.

In an aspect, a computer readable storage medium may bear instructions that, upon execution by a processor, effectuate operations comprising: receiving, via one or more computing devices, first data comprising information relating to an extraction of material at one or more mine sites and a transport of the material to one or more delivery sites external to the one or more mine sites; receiving, via one or more computing devices, second data comprising market data relating to the material, the market data comprising a quantity of the material; determining, via one or more computing devices, an optimization plan based at least on the first data and the second data, the optimization plan comprising a modification to at least one of: the extraction of the material at one or more mine sites and the transport of the material to one or more delivery sites; and generating, via one or more computing devices, an instruction based at least on the determined optimization plan comprising a directive relating to at least one of the following: the extraction of the material at one or more mine sites and the transport of the material to one or more delivery sites.

### BRIEF DESCRIPTION OF THE DRAWINGS

The following detailed description is better understood when read in conjunction with the appended drawings. For the purposes of illustration, examples are shown in the drawings; however, the subject matter is not limited to the specific elements and instrumentalities disclosed. In the drawings:

FIG. 1 illustrates an exemplary mining operation in accordance with aspects of the disclosure;

FIG. 2 illustrates an exemplary mine site in accordance with aspects of the disclosure;

FIG. 3 illustrates a block diagram of an exemplary data flow in accordance with aspects of the disclosure;

FIG. 4 illustrates a block diagram of an exemplary data flow in accordance with aspects of the disclosure;

FIG. 5 illustrates a flow chart of an exemplary method in accordance with aspects of the disclosure;

FIG. 6 illustrates an exemplary mining operation in accordance with aspects of the disclosure;

FIG. 7 illustrates an exemplary mining operation in accordance with aspects of the disclosure; and

FIG. 8 illustrates a block diagram of a computer system configured to implement the method of FIG. 5.

### DETAILED DESCRIPTION

This disclosure provides systems and methods for mining optimization that may be based on market data. For example, mining optimization may be based on an order for a material (e.g., coal or a metal ore) received from a customer. The order may include the price of the material, the grade of the material, the quantity of the material, the location to which the material must be delivered, the time by which it must be delivered, and the like. Together with collected and aggregated data about the mining operation, such as data relating to specific mine sites within the mining operation and site operations therein and data relating to potential transport routes to the delivery location, a mining management system may determine a manner in which the customer's order may be fulfilled most efficiently and/or profitably. As an example, the mining management system may determine which mine sites should provide the materials and which transportation route(s) should be used to transport the materials to the delivery location(s). In certain aspects, mining optimization may be based on a past, current, or projected market price for a material. For example, if the market price of a material is projected to rise, the mining management system may determine that it may be more profitable to perform certain site operations at a particular mine site that are less efficient but increase production, such as increasing the strip ratio threshold at which material is excavated from a pit. Such modifications to site operations are discussed in more detail herein.

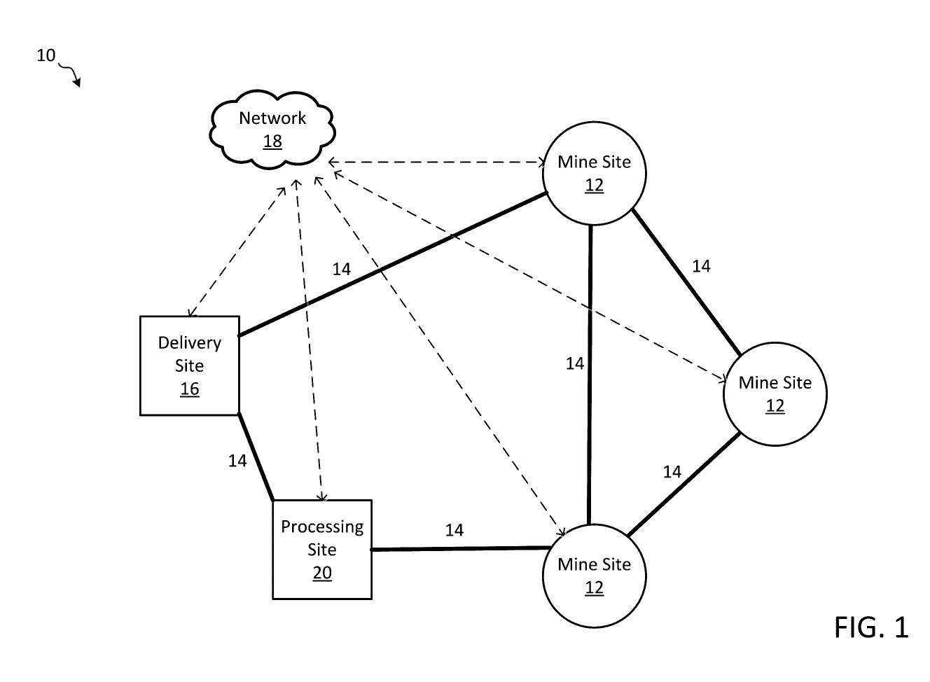

FIG. 1 illustrates a mining operation 10 to extract a material, such as ore, coal, gemstones, shale, oil, etc., from the earth and deliver the material to a customer. The mining operation 10 may include one or more mine sites 12, such as an open-pit mine site, an underground mine site, an oil drilling site, a quarry site, or the like. The mining operation 10 may include a delivery site 16 such as a location at which the material is delivered to a customer. For example, the delivery site 16 may include a customer's ore processing plant, a dump site specified by a customer, a mill, a power plant, a transportation hub (e.g., a shipping port or train depot) at which a customer assumes control of the material, or the like. It will be appreciated that the mining operation 10 may include more than one delivery site 16. The mining operation 10 may additionally include one or more processing sites 20. A processing site 20 may include any facility that processes the material gathered from one or more of the mine sites 12, such as an ore processing facility, a petroleum refinery, chemical plant, or the like. In certain aspects, the processing site 20 may be co-located at the mine site 12.

The mine sites 12 and the delivery site 16 may be interconnected by one or more transport routes 14. A transport route 14 may refer generally to a means of moving a material from one location to another in the mining operation 10. A transport route 14 may include, for example, a sea shipping route (or other standing body of water), a river transport route, a railroad route, air transport route, a truck route, or the like. A transport route 14 may include a route with more than one mode of transportation. As an example, a transport route 14 may include a truck route from an inland mine site 12 to a coastal shipping port and a sea shipping route from the coastal shipping port to a second coastal shipping port serving as the delivery site 16 for the customer. Operating on the transport routes 14 may be one or more vehicles, such as a truck, train, ship, or airplane. The transport routes 14 may each include an appropriate transportation facility. For example, one of the transport routes 14 that includes train transport may include a train depot. Similarly, one of the transport routes 14 that includes truck transport may include a truck loading facility and/or a weigh station.

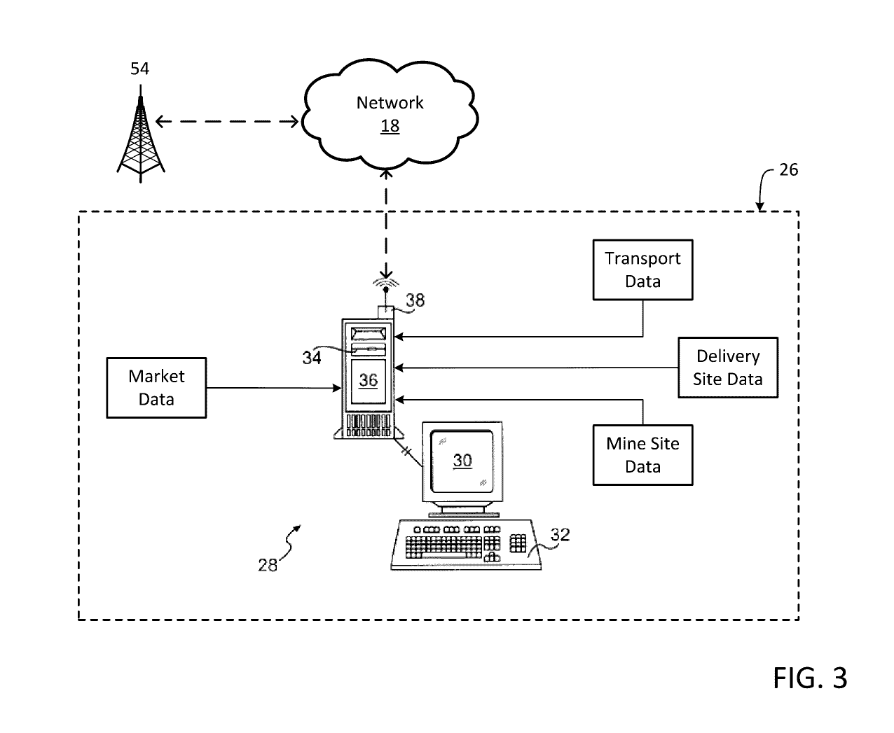

It will be understood that each of the mine sites 12, the delivery sites 16, the processing sites 20, and the transport routes 14 may be owned, operated, controlled, etc. by an entity operating a mining management system (e.g., the mining management system 26 (FIG. 3)) or by third parties. For example, a first entity may control the mine sites 12 and operate an associated mining management system, while a second entity may own one or more of the processing sites 20. Continuing the example, yet a third entity may operate one or more of the transport routes 14.

Each of the mine sites 12, the processing sites 20, and the delivery sites 16 may be in communication with each other, as well as a mining management system (e.g., the mining management system 26 (FIG. 3)), for example, via a network 18. The network 18 may include a cellular network, a satellite network, the Internet, an intranet, a wireless network, a wireline network, or a combination thereof. The communication via the network 18 may extend to one or more of the mine sites 12, the processing sites 20, and the delivery sites 16 and may extend to sub-entities at such sites such as, for example, to machines (e.g., a drilling machine, an excavating machine, a hauling machine, or an ore-processing machine) operating at the location, sensors, computing devices used by personnel at the location, or any other device useful to facilitate market driven mining operations. Elements forming the transport routes 14 (e.g., a truck, a train, a ship, a train station, a shipping port, or trucking depot) may additionally communicate with each other, a mining management system, the mine sites 12, the processing sites 20, and/or the delivery sites 16.

In an aspect, site operations within the mining operation 10, including operations of the mine sites 12, the processing site 20, the delivery site 16, and/or the transport routes 14, may be tracked and logged as data points. For example, mine site data, such as the materials produced, production rate, waste amount, material reserve capacity, and cost of production, for one or more of the mine sites 12 may be collected and stored. Subsequently, the mine site data may be used with market data to create an optimization plan to modify or implement one or more operational aspects of the mining operation 10 that may allow the mining operation 10, or components thereof, to operate at an increased efficiency, productivity, or profitability.

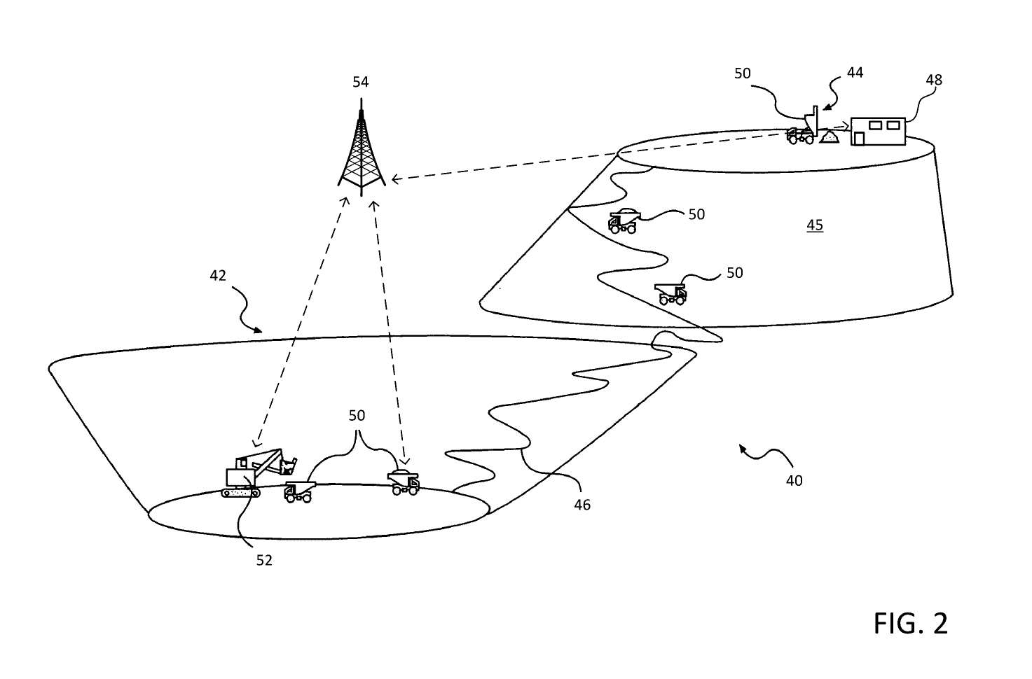

FIG. 2 illustrates an example of one of the mine sites 12, which as depicted here is an open pit mine operation 40 including a pit 42 and a processing region 44 which may be, but is not required to be, on top of a dumping mound 45. A processing plant 48 may be included at the processing region 44. The pit 42 may be connected to the processing region 44 by at least one haul road 46. The haul road 46 may be one of a number of haul roads. A fleet of hauling machines 50 (e.g., an articulated truck, an off-highway truck, an on-highway dump truck, a wheel tractor scraper, or any other similar machine) may travel from the area of excavation of the pit 42 along the haul road 46 to the processing plant 48. In the pit 42, a digging machine 52 (e.g., an excavator, a backhoe, a dozer, a drilling machine, a trencher, a drag line, and the like) may operate to excavate material, which may be ore, overburden, or the like. The excavated material may be suitably loaded into the hauling machine 50 by, for example, a loading machine (e.g., a wheeled or tracked loader, a front shovel, an excavator, a cable shovel, a stack reclaimer, or any other similar machine). Accordingly, the hauling machine 50 may carry a payload when traveling from the pit 42 to the processing plant 48.

In an aspect, the mine site 12 may include a conveyor system (e.g., an in-pit crushing and conveyance (IPCC) system) (not shown) to facilitate material transport between an excavation location, such as the pit 42, and a processing location, such as the processing region 44 and/or between a processing location, such as the processing region 44, and a location at which the material is prepared for transport offsite. In another aspect, the mine site 12 may include a waste dump (not shown) at which waste material, such as overburden, may be deposited.

Each of the machines and/or the processing plant at the mine site 12 may be in communication with each other and with a central station 54 by way of wireless communication to remotely transmit and receive operational data and instructions. In addition or alternatively, the processing plant 48 may be in communication with the central station 54 by way of a wireline network. The central station 54 may, in turn, be connected to the mining management system via the network 18 in order to provide mine site data which may be used to perform market-driven mining operation analytics and determine an optimization plan.

The machines (e.g., the hauling machine 50, the digging machine 52, or the loading machine), processing plant 48, or other elements (e.g., personnel) operating at the mine site 12 may each include one or more sensors coupled with a data control module that records and transmits data to the mining management system 26, via the central station 54 and/or network 18, during its operation on a communication channel as defined herein. As an example, a sensor on one of the machines may gather data relating to machine position, machine speed, machine power source, transmission, traction device, work implement, operator station, or other component and subsystems of the machine. Similarly, vehicles and transportation hubs operating within the transport routes 14 may each include one or more sensors. For example, a train of one of the transport routes 14 may include a sensor that records the position of the train, the speed of the train, a fuel consumption rate, and a weight of the load in one or more of the cars of the train. As another example, a truck loading station may include a scale that records and transmits the weight of a vehicle. Data from the aforementioned sensors may be collected and subsequently used, along with market data, to create a computer model of the mining operation 10 and/or mine site 12, which, in turn, may be used to create an optimization plan for the mining operation 10.

FIG. 3 is a schematic illustration of a mining management system 26 configured to receive and analyze the data communicated via the network 18 from the mine sites 12, processing sites 20, delivery sites 16, transport routes 14, or other source. The mining management system 26 may include a controller 28 in communication with the mining operation 10 via the network 18 and configured to process data from a variety of sources and execute mining management methods within the mining operation 10. The controller 28 may be disposed offsite of the mine sites 12 or may be disposed at one or more of the mine sites 12. For purposes of this disclosure, the controller 28 may be primarily focused on processing data received concerning various aspects of the mining operation 10, including market data, and/or determining an optimization plan for the mining operation 10.

The controller 28 may include any type of computer or a plurality of computers networked together. The controller 28 may be located proximate to one of the mine sites 12 or delivery sites 16 or may be located at a considerable distance remote from one of the mine sites 12 or delivery sites 16, such as in a different city or even a different country. It is also contemplated that computers at different locations may be networked together to form the controller 28, if desired. In one aspect, the controller 28 may be located onboard a machine that is onsite at one or more of the mine sites 12 or delivery sites 16.

The controller 28 may include among other things, a console 30, an input device 32, an input/output device 34, a storage media 36, and a communication interface 38. The console 30 may be any appropriate type of computer display device that provides a graphical user interface (GUI) to display results and information to operators and other users of the mining management system 26. The input device 32 may be provided for operators to input information into the controller 28. The input device 32 may include, for example, a keyboard, a mouse, a touchscreen, or another computer input device. The input/output device 34 may be any type of device configured to read/write information from/to a portable recording medium. The input/output device 34 may include among other things, a floppy disk, a CD, a DVD, a flash memory read/write device, RAM, hard disk, or the like. The input/output device 34 may be provided to transfer data into and out of the controller 28 using a portable recording medium. The storage media 36 may include any means to store data within the controller 28, such as a hard disk. The storage media 36 may be used to store a database containing among others, historical worksite, machine, and operator related data. The communication interface 38 may provide connections with the network 18, enabling the controller 28 to be remotely accessed through computer networks, and means for data from remote sources to be transferred into and out of the controller 28. The communication interface 38 may contain network connections, data link connections, and/or antennas configured to receive wireless data.

Data may be transferred to the controller 28 electronically or manually. Electronic transfer of data may include the remote transfer of data using the wireless capabilities or the data link of the communication interface 38 by a communication channel as defined herein. Data may also be electronically transferred into the controller 28 through a portable recording medium using the input/output device 34. Manually transferring data into the controller 28 may include communicating data to a control system operator in some manner, who may then manually input the data into the controller 28 by way of, for example, the input device 32. The data transferred into the controller 28 may include data useful for determining a market-driven mining optimization, such as market data, transport data, delivery site data, mine site data, and other data. The other data may include for example, weather data (current, historic, and forecast), machine maintenance and repair data, site data such as survey information, geological data, or soil test information, and other data known in the art.

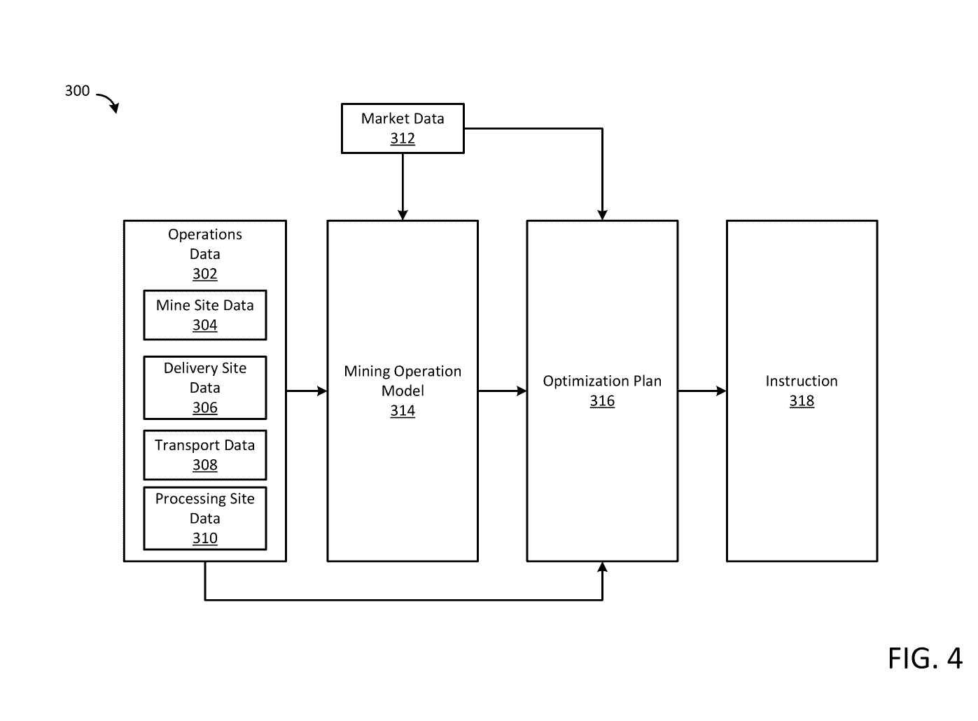

FIG. 4 depicts an exemplary flow diagram 300 of various operations relating to a method to optimize mining operations according to market data. In an aspect, a mining operation model 314 (e.g., mine plan) may be accessed, received, or generated. The mining operation model 314 may simulate the operations of the mining operation 10, including operations between the mine sites 12, the processing sites 20, and the delivery sites 16. For example, it may be simulated that one of the mine sites 12 produces a quantity of ore and a truck in one of the transport routes 14 connected to the mine site 12 receives the ore and transports the ore to one of the processing sites 20. The mining operation model 314 may further simulate the processing site 20 processing the ore into a refined product, such as a metal, and a ship in another of the transport routes 14 receiving the finished product and delivering it to the delivery site 16. The mining operation model 314 may further include a model of the discrete operations at the mine sites 12, processing sites 20, delivery sites 16, and/or transport routes 14. As an example, the model of one of the mine sites 12 may include simulating the operation of a loading machine depositing a material into a hauling machine. The model may, in turn, simulate the laden hauling machine traveling along a road and unloading its payload to a dump site. The model may then simulate the empty hauling machine traveling back over the road to repeat the process. The mining operation model 314 may be determined by the controller 28 or other processor. For example, the mining operation model 314 may be determined at a server or other processor controlled by a third-party and subsequently delivered to and received by the controller 28.

The mining operation model 314 may be determined based on a variety of inputs relevant to the mining operation 10 and components thereof (e.g., the mine site 12, the processing site 20, the transport route 14, or the delivery site 16.) The mining operation model 314 may be based on operations data 302, market data 312, or other data.

Operations data 302 may include any data reflecting the past, current, or projected operations of the mining operation 10. Operations data 302 may include mine site data 304, delivery site data 306, transport data 308, and/or processing site data 310.

Mine site data 304 may include any information representing the past, current, or projected operations at the mine sites 12. Mine site data 304 may include data on the operation of the machines at the mine site 12, including performance metrics relating to individual machines (e.g., the capacity of a hauling machine, the material/minute rate of a loading machine, the extraction rate of an excavator, the fuel consumption rate of a machine, the average speed of a hauling machine, or the drill rate of a drilling machine) or performance metrics relating to the cooperative operation of multiple machines (e.g., the amount of time that a loading machine takes to fill the bed of a hauling machine). Performance metrics may be input from sensors onboard the machines or otherwise situated at the mine site 12 and may include operator manipulation of the input devices, tool, or power source, machine velocity, machine location, fluid pressure, fluid flow rate, fluid temperature, fluid contamination level, fluid viscosity, electric current level, electric voltage level, fluid (e.g., fuel, water, oil, coolant, diesel exhaust fluid) consumption rates, payload level, payload value, percent of maximum allowable payload limit, payload history, payload distribution, transmission output ratio, cycle time, idle time, grade, recently performed maintenance, or recently performed repair.

Mine site data 304 may include metrics pertaining to the performance or capacity of one of the mine sites 12 as a whole. For example, this may include data pertaining to the mine site's 12 production, i.e., production data. Production data may include an indication of materials produced or capable of being produced by the mine site 12, including grade of the materials. As another example, production may include a rate at which material may be produced or extracted. Production data may further include an indication of capacity for a material produced at the mine site 12. The indication of capacity for a given material may include a short term capacity, such as the amount of a material that may be produced in a month's time, or a long term capacity, such as the amount of a material that may be produced in a five year period. The indication of capacity may include an absolute capacity for a material. For example, an indication of absolute capacity may reflect that 1,000,000 tons of coal remain in the coal deposit at the mine site 12 before being exhausted. The indication of capacity may further reflect an index of other metric reflecting a potential for the mine site 12 to modify its production. For example, this may indicate that the mine site 12 may only increase production by 10,000 tons a month or by a 10% increase. Mine site data 304 may further include information pertaining to a stockpile or inventory of material at the mine site 12, including an actual amount of material stockpiled at the mine site 12 and/or a potential amount of material that the mine site 12 is capable of storing.

The mine site data 304 may include information on one or more pits at the mine site 12, such as the number of pits, the material of a pit, the strip ratio for a pit, and capacity information for a pit. Information pertaining to blast-hole drilling at the mine site 12 may also be included in the mine site data 304. For example, this may include a drilling rate, a pattern spacing, a drill depth, and/or a drill angle. The mine site data 304 may further include geological information relating to the mine site 12. The mine site data 304 may additionally include information on the layout and planning of one of the mine sites 12. This may include the locations of material, a pit, a drilling rig, a processing machine, and one or more roads. Additionally, information on the layout of the mine site 12 may include the location of a dump zone, a scale, a loadout, or the like. The mine site data 304 may include data pertaining to the re-handling of material (i.e. the temporary storage of material after it has been excavated but before it has been processed or loaded for transport) at the mine site 12, such as the location of a temporary dump location and the amount of material stored therein.

The mine site data 304 may include cost-related information. Cost-related information may include a purchase cost of a machine, a lease cost of a machine, an operating cost of a machine (e.g., fuel, wear-and-tear deterioration), or the like. Other cost-related information may include wage costs for personnel associated with the mine site 12, including those personnel operating the machines (e.g., the hauling machine 50, the digging machine 52, or the loading machine). Cost-related information may additionally include road construction cost, road maintenance cost, and power costs such as for electricity or natural gas. Costs associated with particular activities may also be included, such as the cost of removing surplus or waste or the cost of blast-hole drilling.

The delivery site data 306 may include information on the delivery site 16, including a location of the delivery site 16 and type (e.g., shipping port, truck dump site, etc.).

The processing site data 310 may include any information pertaining to the processing site 20. This may include an indication of the materials that the processing site 20 is capable of processing and/or the processing rate of those materials (e.g., 20 tons of ore processed an hour). Processing site data 310 may additionally include information relating to an inventory of material at the processing site 20, such as an amount of un-processed material and/or an amount of processed material. Processing site data 310 may include cost information, such as the general cost of operating the processing site 20 and/or the cost of processing a given material. The location of the processing site 20 may additionally be included in the processing site data 310.

The transport data 308 may include any information on the transport routes 14. Transport data 308 may include the distance of the transport route 14, an indication of the transportation means or vehicle of the transport route 14 (e.g., ship, train, truck, etc.), and/or an indication of the nature of the transport route 14 (e.g., road, rail, pipeline, river, or standing water). Transport data 308 may include an indication of materials that may be transported over the transport route 14. As an example, one of the transport routes 14 that is a pipeline would obviously be unable to transport any sort of ore or other solid material. Transport data 308 may include cost information, such as the cost of transport over the transport route 14, and timing information, such as the amount of time for the transportation means to traverse the transport route 14. Cost and timing information may, in part, be a function of other aspects of the mining operation 10 operations, such as the nature of the material being transported. For example, if the material is particularly heavy, the cost of transport may be higher than for a lighter material due to increased fuel costs and/or weight-based taxes, levies, or fees. Similarly, a transportation means may be forced to travel more slowly with a heavier load and thus increase the time to traverse the transport route 14.

The market data 312 may include information related to the economic market for one or more materials. Market data 312 may include data on the economic market for a material in general. For example, market data 312 may include a current, past, or projected trading price of a particular material. The current or past trading prices may be derived from a trading price on a commodity exchange. Market data 312 may include an index or other indicator of demand for a material. Market data 312 may include an indication of a trend concerning the price of a material (e.g., the price of the material is anticipated to rise over a certain period). The trend concerning the price of a material may be a short term trend (e.g., within one month), a mid-term trend (e.g., from one month to one year), or a long term trend (greater than one year). Market data 312 may additionally include data relating to a specific transaction, order, or offer. Market data 312 relating to a specific transaction, order, or offer may include an identification of the customer, identification of a material, a grade of the material, a purchase price of the material, a quantity of the material, a delivery location for the material, and/or a date or time period by which the material must be delivered. To illustrate, a company operating the mining operation 10 may receive an offer to buy 10,000 tons of bituminous coal at $50 per ton, delivered to a port in Newport News, Va., by Dec. 31, 2015. In an aspect, an order reflected in the market data 312 may embody an agreement in which a certain quantity of material, at a certain rate, is to be delivered at fixed time intervals within a time range. For instance, an agreement may provide that 10,000 tons of coal are to be delivered to a power plant by the first day of each month of the upcoming year.

In an aspect, the mining operation model 314 may be generated using a filter process in which certain aspects of the operations data 302 are excluded from the mining operation model 314 based on the market data 312. Market data 312 relevant to the filter process may include, for example, material, material grade, delivery location, and timing information. As an illustration, market data 312 may represent a customer order for gold ore. The filter process may exclude from the generation of the mining operation model 314 all operations data 302 that is irrelevant to the production, transport, and delivery of gold ore. For example, if one of the mine sites 12 is only capable of producing coal, all mine site data 304 concerning that mine site may be excluded from the generation of the mining operation model 314. The filter process may serve the benefit of a reduced computation time for the mining operation model 314 and thus improve the performance of a computer generating the mining operation model 314, such as the controller 28.

In an aspect, mining operation analytics may be performed based on the mining operation model 314, the market data 312, and/or the operations data 302 to determine an optimization plan 316 for mining operation 10 operations. The optimization plan 316 may include a determination of one or more operational aspects of the mining operation 10 that may be implemented or modified in order to effectuate, for example, a successful and cost-efficient fulfillment of a material order, an increase in profitability, an increase in productivity, an increase in efficiency, or other desirable outcome. The operational aspect may include an aspect of the mining operation 10 at an enterprise level, such as a function (e.g., the production rate) of one of the mine sites 12 as a whole or a choice among several potential transport routes 14. The operational aspect may additionally or alternatively include an aspect of the discrete operations within one or more of the mine sites 12, the processing site 20, the delivery site 16, or the transport routes 14. With respect to one of the mine sites 12, this may be known as a mine level operational aspect. As examples, the operational aspect may include the digging machines 52 excavating raw material with a particular strip ratio, the hauling machines 50 operating at a particular speed, along a particular route, and/or at a particular fuel consumption level, and/or a drilling rig performing blast-hole drilling with a particular pattern spacing and quantity of explosive.

In one aspect, the mining operation analytics may leverage market data 312 reflecting general market conditions for one or more materials. The general market conditions may include a past or current price or other index of demand for a material. As discussed further herein, the price may be derived, for example, from a commodity exchange. The general market conditions may further include a projected future price for the material or an indication of a trend for the price (e.g., the price of the material is anticipated to rise over a certain period).

In another aspect, the mining operation analytics may leverage specific market data 312 reflecting a transaction, order, or offer. For example, a transaction or offer may include an indication of a material, the quality or grade of the material, the purchase price of the material, a data or time period by which the material must be delivered, the location to which the material is to be delivered, and/or the means by which the material is to be delivered. It will be appreciated that the mining operation analytics may leverage market data 312 reflecting both general market conditions and a transaction or offer. For example, the optimization plan 316 may be determined with consideration to an order for coal that must be fulfilled in one month, but also with consideration to general market data that indicates that the price of coal is expected to rise in subsequent months.

The optimization plan 316 may be determined by a consideration of factors in the operations data 302 that relate to the market data 312. For example, if the market data 312 identifies coal as the relevant material, relevant factors in the operations data 302 may include an identification of one or more mine sites 12 that produce coal and mine site data 304 (e.g., coal production rate and/or capacity, an amount of surplus that must be removed before reaching coal deposits, personnel availability, on-site processing plant processing rate and/or capacity, and other operations data relevant to coal production) for the identified mine sites 12. Continuing the example, other relevant factors in the operations data 302 may additionally include an identification of transport routes 14 connected, directly or indirectly, to the coal-producing mine sites 12 and transport data 308 (e.g., indication of transportation means, distance, time, and/or cost) for the identified transport routes 14. Still continuing the example, relevant factors in the operations data 302 may include an identification of one or more processing sites 20 that are capable of processing coal and processing site data 310 (e.g., processing rate, cost of processing, and/or availability of processing equipment) for the identified processing sites 20. While the preceding example focuses on the identification of coal as a material included in the market data 312, it will be appreciated that other aspects of the market data 312 may be considered, such as a delivery time, delivery location, and/or price. For example, if the market data 312 identifies a particular one of the delivery sites 16 as the delivery location for an order, the optimization plan 316 may be determined based, in part, on portions of the mine site data 304 for mine sites 12 that are connected directly or indirectly to the identified delivery site 16, thereby not considering or discarding the portions of the mine site data 304 for the mine sites 12 that are not connected to the identified delivery site 16.

The leveraging of the market data 312 to determine the optimization plan 316 may function as a filtering process whereby potentially large portions of available operations data 302 (i.e., the portions of operations data that have little or no relevance to the market data 312) may be discarded from the mining operation analytics. For example, if the market data 312 indicates an order for iron ore, portions of the operations data 302 that are only relevant to coal, may be discarded from the mining operation analytics. Examples of operations data 302 that may be discarded in this instance may include mine site data 304 for one of the mine site 12 that only produces coal or transport data 308 for a transport route 14 that is particularly configured to transport coal, but not metal ores such as iron ore. Leveraging the market data 312 in this way may serve the benefit of a reduced computation time for the optimization plan 316 and thus improve the performance of a computer generating the optimization plan 316, such as the controller 28.

In an aspect, the optimization plan 316 may be short term (a period of one work day), intermediate term (a period of more than one work day to less than one year), or long term (a period of one year or more). The optimization plan 316 may include aspects of more than one of the aforementioned terms (e.g., the optimization plan 316 may include a short-term aspect and long-term aspects). As an example, the operations data 302 may reflect that a certain mine site contains a reserve of material under a large quantity of overburden that will take six months to remove and the market data 312 may reflect that the price of the material is expected to go down in six months' time. In this example, a long term optimization plan may include not removing the overburden during the six month period since the price is expected to be lower by the time the material could be excavated and thus be less profitable.

In an aspect, the optimization plan 316 may be based on short term (a period of one work day), intermediate term (a period of more than one work day to less than one year), or long term (a period of one year or more) data from the operations data 302 and/or the market data 312. For example, the optimization plan 316 may be based on the short term data in the market data 312 that the price of particular material is a particular amount on the current work day. As another example, the optimization plan 316 may be based on the intermediate term data in the operations data 302 that a certain transport route 14 will be available for transporting ore at a certain price for the next three months. As yet another example, the optimization plan 316 may be based on the long term data in the operations data 302 that the price of a particular material is projected to rise after six months. It will be appreciated that the optimization plan 316 may be determined based on more than one term-type of data. For example, the optimization plan 316 may be determined based both on the intermediate term data in the market data 312 that a customer order for iron ore is due in two months and the long term data in the operations data 302 that the iron ore from a first mine site will be depleted in six months and the iron ore from a second mine site will be depleted in one year. It will be further appreciated that short term data may be used in determining a long term optimization plan, long term data may be used in determining a short term optimization plan, and so forth.

In an aspect, an instruction 318 is generated based on the optimization plan 316. The instruction 318 may be generated and further transmitted by the controller 28 of the mining management system 26, for example. The instruction 318 may be further transmitted, via the network 18, to one of more of the mine sites 12 (including the central station 54), the processing site 20, the delivery site 16, and the transport routes 14. The instruction 318 may be further transmitted to machines (e.g., hauling machine 50, digging machine 52, or a loading machine), the processing plant 48, or personnel at one of the mine sites 12. The instruction 318 may relate to an operational aspect identified in the optimization plan 316 that may be implemented or modified to effectuate a fulfillment of a material order, an increase in profitability, an increase in productivity, an increase in efficiency, or other desirable outcome. For example, if the optimization plan 316 identified that the market price of iron ore had increased and that iron ore may be profitably excavated at an increased strip ratio, the instruction 318 may direct one or more of the mine sites 12 producing iron ore to excavate iron ore at or above the increased strip ratio (e.g., a 3:1 ratio of waste to ore instead of the present or past 2:1 ratio). As another example, if the optimization plan 316 identified that a customer order for coal required that the coal be delivered to the delivery site 16 and that the coal may be transported more cost-effectively and within the allotted time frame via a particular one of the transport routes 14, the instruction may direct that the mine site 12 to load the coal onto a vehicle operating within the particular transport route 14 and that the vehicle transport the coal along the transport route 14.

In an aspect, the mining operation model 314 and/or the operations data 302 may be updated based on the mining operation analytics, optimization plan 316, and/or the instruction 318 (before or after implementation). For example, the mining operation model 314 may be updated in order to validate the optimization (e.g., compare the projected result of the optimization plan 316 with the actual results). As another example, the mining operation model 314 may be updated to test predictive outcomes of the optimization plan 316 in order to compare potential optimization plans and their predictive outcomes.

### INDUSTRIAL APPLICABILITY

The industrial applicability of the systems and methods for optimizing mining operation 10 operations based, in part, on market data 312 described herein will be readily appreciated from the foregoing discussion.

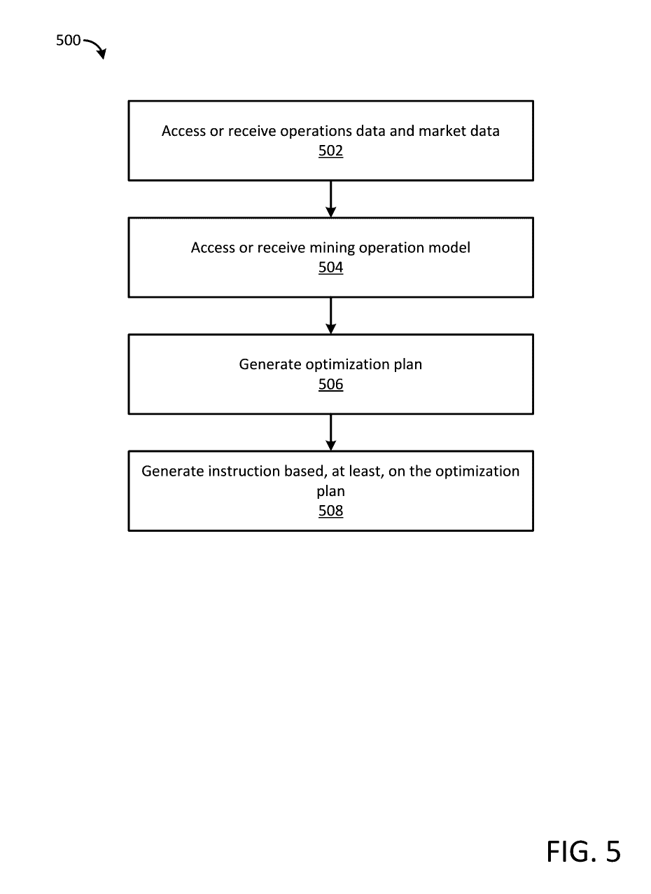

FIG. 5 illustrates a process flow chart for a method 500 for market-driven mining optimization. For illustration, the operations of the method 500 will be discussed in reference to FIGS. 1-4. At step 502, the operations data 302 and/or the market data 312 may be accessed or received. As an example, the operations data 302 and/or the market data 312 may be received by the controller 28. The operations data 302 and/or the market data 312 may be previously stored on the controller 28 or may be received from another server or processor, including one associated with a third party.

The operations data 302 may include any data reflecting the past, current, or projected operations of the mining operation 10, including the mine site data 304, the delivery site data 306, the transport data 308, and/or the processing site data 310. The mine site data 304 may include any information representing the past, current, or projected operations at the mine sites 12, such as performance metrics relating to machines (e.g., from sensors onboard machines), performance or capacity data relating to a whole mine site (e.g., material capacity or rate of material production), pit data, blast-hole drilling data, mine site layout information, and/or cost related information. Delivery site data 306 may include information on the delivery site 16, such as the location of the delivery site 16 and type (e.g., shipping port, truck dump site, etc.). Transport data 308 may include any information on the transport routes 14, such as distance, transportation means (e.g., ship, train, truck, or the like), the nature of the transport route 14 (e.g., road, rail, river, or standing water), cost information, capability to transport certain materials, and/or timing information. Other data may be received or accessed and may be used in processing the collective data.

Market data 312 may include any information related to the economic market for one or more materials. Market data 312 may include data on the economic market for a material in general, such as a current, past, or projected trading price of a material or an indication of a trend concerning the price of a material. Market data 312 may additionally include data relating to a specific transaction, order, or offer. Market data 312 relating to a specific transaction, order, or offer may include an identification of the customer, identification of a material, a grade of the material, a purchase price of the material, a quantity of the material, a delivery location for the material, and/or a data or time period by which the material must be delivered.

At step 504, a mining operation model (e.g., the mining operation model 314) may be accessed, received, or generated that simulates the operations of the mining operation 10, including the operations of the mine sites 12, the processing site 20, the delivery site 16, and/or the transport routes 14. The mining operation model may be accessed or received by the controller 28, for example, after the mining operation model is determined based, at least in part, on the operations data 302 and/or the market data 312. The determination of the site model may be performed by the controller 28 or another processor, including one controlled by a different party than that controlling the controller 28.

At step 506, mining operation analytics are performed to generate the optimization plan 316 for mining operation 10 operations based on the mining operation model 314, the market data 312, and/or the operations data 302. The mining operation analytics may be performed by, for example, the controller 28. The optimization plan 316 may include a determination of one or more operational aspects of the mining operation 10 that may be implemented or modified in order to effectuate, for example, a successful and cost-efficient fulfillment of a material order, an increase in profitability, an increase in productivity, an increase in efficiency, or other desirable outcome. The operational aspect may include an aspect of the mining operation 10 at an enterprise level. The operational aspect may additionally or alternatively include an aspect of the discrete operations within one or more of the mine sites 12, the processing site 20, the delivery site 16, or the transport routes 14. The mining operation analytics may leverage general market data (e.g., the market price of a material), specific market data (e.g., a transaction, order, or offer for material), or a combination thereof. The optimization plan 316 plan may be determined based on portions of the operations data 302 that relate to the market data 312

At step 508, the instruction 318 is generated based on the optimization plan 316. The instruction 318 may be generated by, for example, the controller 28 of the mining management system 26. The instruction may relate to an operational aspect identified in the optimization plan 316 that may be implemented or modified to effectuate a fulfillment of a material order, an increase in profitability, an increase in productivity, an increase in efficiency, or other desirable outcome. As examples, the instruction 318 may direct one of the mine sites 12 to excavate ore at or above a specified strip ratio or direct that a produced material to be transported over a specified transport route 14.

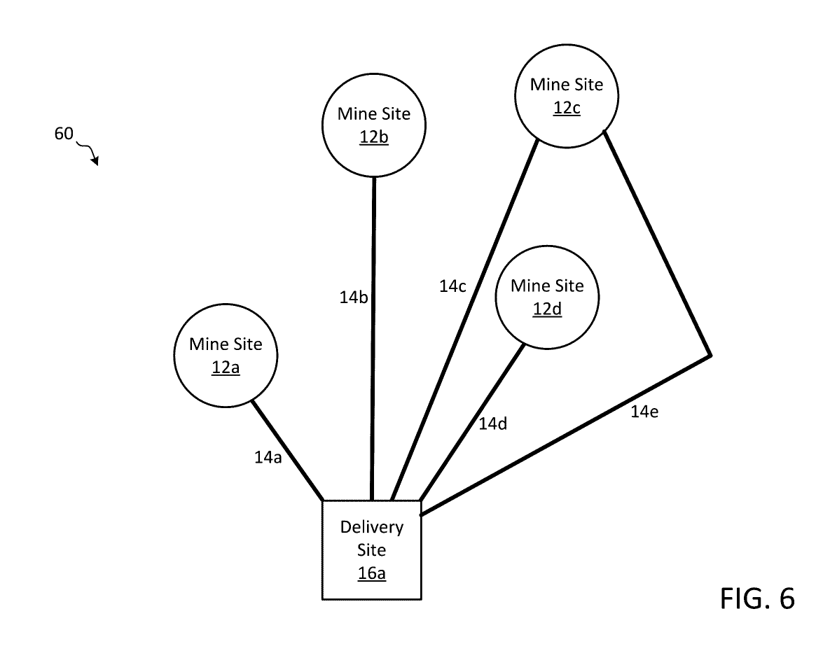

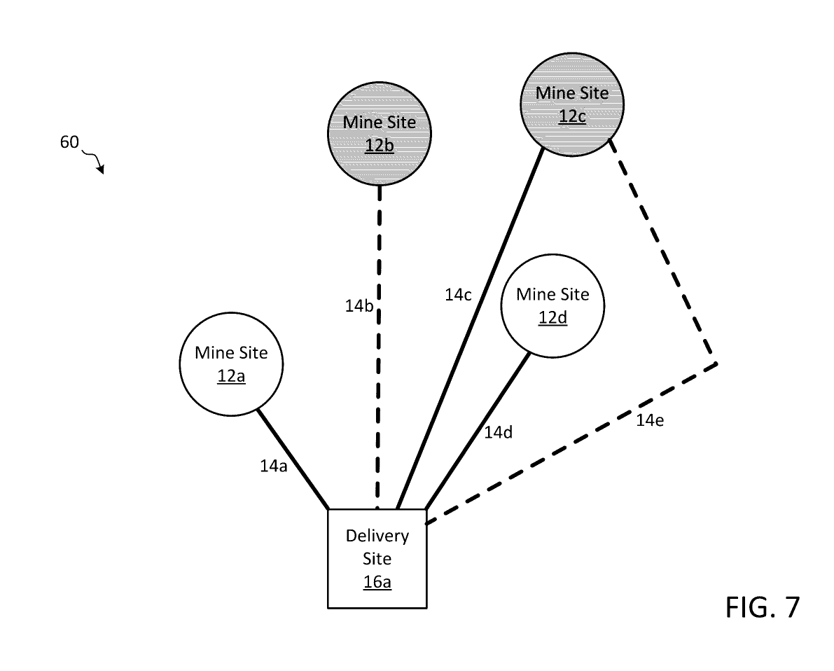

A detailed example of the method 500 shall now be provided with reference to FIGS. 6 and 7. FIG. 6 illustrates a mining operation 60, which is an exemplary aspect of the mining operation 10. FIG. 7 also illustrates the mining operation 60, but represents the state of the mining operation 60 according to a determined optimization plan. The mining operation 60 includes mine sites 12a-d, which are each exemplary aspects of the mine site 12, and a delivery site 16a, which is an exemplary aspect of the delivery site 16. The mine sites 12a-d are connected to the delivery site 16a by transport routes 14a-e.

Operations data (e.g., the operations data 302) is accessed or received that reflects that mine site 12a produces coal at a rate of 20 units per month and has an absolute capacity of 100 units of coal, mine site 12b produces coal at a potential rate of 5 units per month and has an absolute capacity of 200 units of coal, mine site 12c also produces coal at a potential rate of 5 units per month and has an absolute capacity of 200 units of coal, and mine site 12d produces iron at a potential rate of 10 units per month and an absolute capacity of 100 units of iron ore. The operations data also reflects that transport route 14a is 100 miles, has an associated transport cost of $100, and a transport time of 5 days; transport route 14b is 300 miles, has an associated transport cost of $200, and a transport time of 10 days; transport route 14c is 350 miles, has an associated transport cost of $200, and a transport time of 12 days; and transport route 14d is 600 miles, has an associated transport cost of $100, and a transport time of 25 days. It will be appreciated that the units and values used in this example and elsewhere herein are for comparative and illustrative purposes only.

Market data (e.g., the market data 312) is accessed or received that indicates that the company operating the mining operation 60 has accepted an order for 10 units of coal, deliverable to the delivery site 16a in two months. The market data also reflects that the price of coal is expected to trend sharply upwards over the upcoming six months and then decrease sharply in the subsequent six months.

In order to fulfill this order, a mining operation model (e.g., the mining operation model 314) is generated that simulates the operation of the mining operation 60, including the operations data and the market data. Based on the mining operation model, the operations data, and/or the market data, mining operation analytics are performed to generate an optimization plan (e.g., the optimization plan 316). The optimization plan will determine one or more operational aspects of the mining operation 60 operation that may be implemented or modified in order to fulfill the order for the 10 units of coal in the most efficient and profitable way. It will be appreciated that the operational aspects and operations data of mine site 12d may be substantially discarded or filtered out since mine site 12d produces iron ore and not coal and thus will have little direct influence upon the fulfillment of the order for coal.

Mine site 12a has the requisite potential production rate (20 units per month) to fulfill the order and the transport time of the coal from mine site 12a over transport route 14a (5 days) would be sufficient. Yet with consideration to the projected trend of the price of coal over the next 12 months, fulfilling the order from mine site 12a may be less profitable as compared to fulfilling the order from mine site 12b and mine site 12c, which, combined, have the requisite potential production rates (5 units per month, each) and sufficient transport routes. Since mine site 12a has a higher production rate but a lower absolute capacity than those of mine site 12b and 12c, it may be more profitable for mine site 12a to suspend production in the first month (and thus not consume part of its limited 100 unit absolute capacity) and then produce its 20 unit maximum in the subsequent five months, in which the price of coal is projected to rise. Thus the optimization plan will determine that mine site 12a will not fulfill the order but will operate at its maximum production rate in the subsequent months and mine site 12b and mine site 12c will each produce 5 units of coal in the coming month and fulfill the order. The determination that mine site 12b and mine site 12c will each produce the coal to fulfill the order is represented by the graying-in of mine site 12b and mine site 12c in FIG. 7.

Given that mine site 12b and mine site 12c are determined in the optimization plan to fulfill the order for coal, it must still be determined which of the transport routes should be used in order to maximize profitability and efficiency. The coal from mine site 12b will be transported via transport route 14b. The transporting of the coal from mine site 12b is represented by the dotted line of transport route 14b in FIG. 7. The coal from mine site 12c may potentially be transported via either transport route 14c or transport route 14e. Transport route 14c may appear to be an obvious choice since it is shorter and quicker than transport route 14e. Transport route 14e, however, will be determined as the most efficient and/or profitable route since it has a transport cost of $100—less than the $200 transport cost of transport route 14c and the 25 day transport time of transport route 14e is sufficient to fulfill the order on time (the one month production time plus the 25 day transport time is within the two month delivery period). The transporting of the coal from mine site 12c is represented by the dotted line of transport route 14e in FIG. 7. This example may serve to illustrate that, by collecting and aggregating a large set of operational and market data, the mining management system 26 may determine an optimization plan that is counter-intuitive to a human being, even one skilled in the art of mining operation management. A human being would not be able to appreciate the complex interactions of the many elements and factors of a mining operation and make the most efficient or profitable determination for an operational aspect of the mining operation.

An instruction (e.g., the instruction 318) is generated based on the optimization plan and the instruction, or a portion thereof, is transmitted to each of the mine sites 12a-e and transport routes 14a-e. The instruction will direct mine site 12a to not fulfill the order for coal and then operate at its maximum production rate for the subsequent five months. The instruction will direct mine site 12b and mine site 12 to each produce 5 units of coal in the coming month. The instruction will further direct transport route 14b to transport the coal from mine site 12b to the delivery site 16a and transport route 14e to transport the coal from mine site 12c to the delivery site 16a.

As another detailed example of the method 500, a mining operation (e.g. the mining operation 10) may include a mine site producing gold ore. The mine site may produce the gold ore using a blast-hole drilling process. Operations data (e.g., the operations data 302) is accessed or received that indicates that the mine site produces gold ore at a rate of 10 units per month at a production cost of $1000 per unit and that the blast-hole drilling process is performed with a pattern spacing of 10 meters between drillings and 5 units of explosives per blast. Market data (e.g., the market data 312) is accessed or received that indicates that the market price of gold ore has risen from $1200 per unit to $1600 per unit.

After accessing or receiving the operations data and market data, a mining operation model (e.g., the mining operation model 314) is generated that simulates operation of the mining operation and the mine site, including the operations data and the market data. Based on the mining operation model, the operations data, and/or the market data, mining operation analytics are performed to generate an optimization plan (e.g., the optimization plan 316). The optimization plan will determine one or more operational aspects of the mine site that may be implemented or modified in order to increase the profitability and/or production of the mine site.

Since the market data indicates that the price of gold ore has risen, an operational aspect of the mine site may be modified or implemented based on the rise in price. In particular, the pattern spacing and amount of explosive may be modified so that the blast-hole process operates in a manner that is less efficient but increases production and is still profitable based on the rise in market price. To this end, the pattern spacing may be increased to, for example, 15 meters and the amount of explosives used per blast may be increased to, for example, 8 units. Such a change would increase the per-unit cost of producing gold ore to, for example, $1300 per unit but would increase the amount of gold ore that may be produced to 15 units. This change would render the mine site unprofitable under the previous market price of gold ore (i.e., the $1300 cost would be more than the $1200 previous price). But with the increase in market price to $1600, this change would result in an increase to profitability and production.

An instruction (e.g., the instruction 318) is generated based on the optimization plan and the instruction, or a portion thereof, is transmitted to the mine site. The instruction will direct the mine site to increase the blast-hole pattern spacing to 15 meters and the amount of explosives used per blast to 8 units of explosives, thereby increasing the profitability and production of the mine site.

Whether such functionality is implemented as hardware or software depends upon the design constraints imposed on the overall system. Skilled persons may implement the described functionality in varying ways for each particular application, but such implementation decisions should not be interpreted as causing a departure from the scope of the disclosure. In addition, the grouping of functions within a module, block, or step is for ease of description. Specific functions or steps may be moved from one module or block without departing from the disclosure.

The various illustrative logical blocks and modules described in connection with the aspects disclosed herein may be implemented or performed with a general purpose processor, a digital signal processor (DSP), application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices, for example, a combination of a DSP and a microprocessor, a plurality of microprocessors, one or more microprocessors in conjunction with a DSP core, or any other such configuration.

The steps of a method or algorithm described in connection with the aspects disclosed herein may be embodied directly in hardware, in a software module executed by a processor (e.g., of a computer), or in a combination of the two. A software module may reside, for example, in RAM memory, flash memory, ROM memory, EPROM memory, EEPROM memory, registers, hard disk, a removable disk, a CD-ROM, or any other form of storage medium. An exemplary storage medium may be coupled to the processor such that the processor may read information from, and write information to, the storage medium. In the alternative, the storage medium may be integral to the processor. The processor and the storage medium may reside in an ASIC.

In at least some aspects, a processing system (e.g., the controller 28) that implements a portion or all of one or more of the technologies described herein may include a general-purpose computer system that includes or is configured to access one or more computer-accessible media.

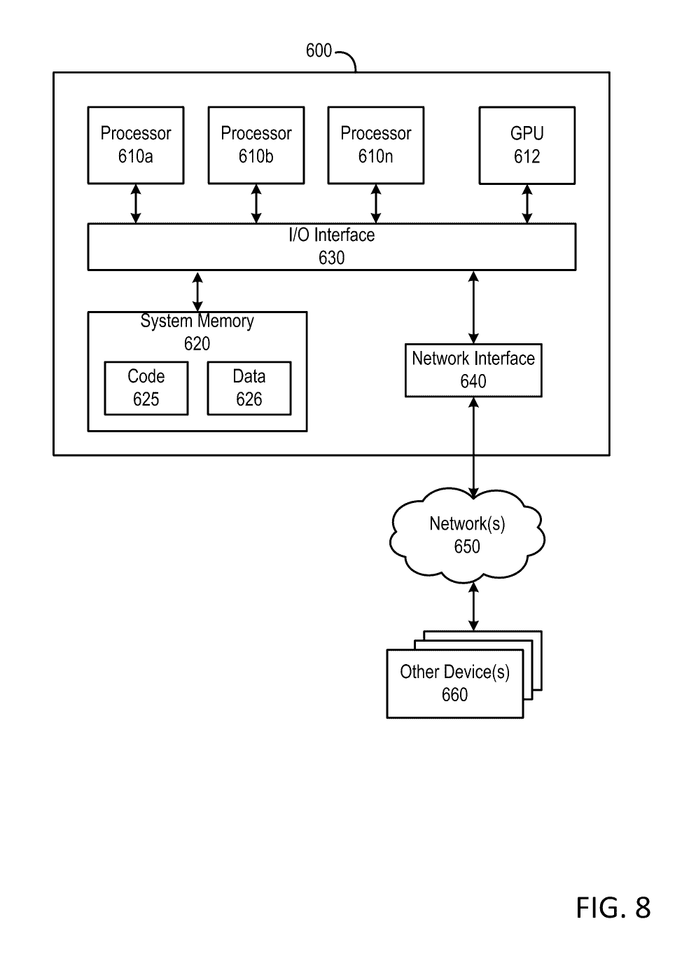

FIG. 8 depicts a general-purpose computer system that includes or is configured to access one or more computer-accessible media. In the illustrated aspect, a computing device 600 may include one or more processors 610a, 610b, and/or 610n (which may be referred herein singularly as the processor 610 or in the plural as the processors 610) coupled to a system memory 620 via an input/output (I/O) interface 630. The computing device 600 may further include a network interface 640 coupled to an I/O interface 630.

In various aspects, the computing device 600 may be a uniprocessor system including one processor 610 or a multiprocessor system including several processors 610 (e.g., two, four, eight, or another suitable number). The processors 610 may be any suitable processors capable of executing instructions. For example, in various aspects, the processor(s) 610 may be general-purpose or embedded processors implementing any of a variety of instruction set architectures (ISAs), such as the x86, PowerPC, SPARC, or MIPS ISAs, or any other suitable ISA. In multiprocessor systems, each of the processors 610 may commonly, but not necessarily, implement the same ISA.

In some aspects, a graphics processing unit (“GPU”) 612 may participate in providing graphics rendering and/or physics processing capabilities. A GPU may, for example, include a highly parallelized processor architecture specialized for graphical computations. In some aspects, the processors 610 and the GPU 612 may be implemented as one or more of the same type of device.

The system memory 620 may be configured to store instructions and data accessible by the processor(s) 610. In various aspects, the system memory 620 may be implemented using any suitable memory technology, such as static random access memory (“SRAM”), synchronous dynamic RAM (“SDRAM”), nonvolatile/Flash®-type memory, or any other type of memory. In the illustrated aspect, program instructions and data implementing one or more desired functions, such as those methods, techniques and data described above, are shown stored within the system memory 620 as code 625 and data 626.

In one aspect, the I/O interface 630 may be configured to coordinate I/O traffic between the processor(s) 610, the system memory 620 and any peripherals in the device, including a network interface 640 or other peripheral interfaces. In some aspects, the I/O interface 630 may perform any necessary protocol, timing or other data transformations to convert data signals from one component (e.g., the system memory 620) into a format suitable for use by another component (e.g., the processor 610). In some aspects, the I/O interface 630 may include support for devices attached through various types of peripheral buses, such as a variant of the Peripheral Component Interconnect (PCI) bus standard or the Universal Serial Bus (USB) standard, for example. In some aspects, the function of the I/O interface 630 may be split into two or more separate components, such as a north bridge and a south bridge, for example. Also, in some aspects some or all of the functionality of the I/O interface 630, such as an interface to the system memory 620, may be incorporated directly into the processor 610.

The network interface 640 may be configured to allow data to be exchanged between the computing device 600 and other device or devices 660 attached to a network or networks 650, such as other computer systems or devices, for example. In various aspects, the network interface 640 may support communication via any suitable wired or wireless general data networks, such as types of Ethernet networks, for example. Additionally, the network interface 640 may support communication via telecommunications/telephony networks, such as analog voice networks or digital fiber communications networks, via storage area networks, such as Fibre Channel SANs (storage area networks), or via any other suitable type of network and/or protocol.

In some aspects, the system memory 620 may be one aspect of a computer-accessible medium configured to store program instructions and data as described above for implementing aspects of the corresponding methods and apparatus. However, in other aspects, program instructions and/or data may be received, sent, or stored upon different types of computer-accessible media. Generally speaking, a computer-accessible medium may include non-transitory storage media or memory media, such as magnetic or optical media, e.g., disk or DVD/CD coupled to computing device the 600 via the I/O interface 630. A non-transitory computer-accessible storage medium may also include any volatile or non-volatile media, such as RAM (e.g., SDRAM, DDR SDRAM, RDRAM, SRAM, etc.), ROM, etc., that may be included in some aspects of the computing device 600 as the system memory 620 or another type of memory. Further, a computer-accessible medium may include transmission media or signals, such as electrical, electromagnetic or digital signals, conveyed via a communication medium, such as a network and/or a wireless link, such as those that may be implemented via the network interface 640. Portions or all of multiple computing devices, such as those illustrated in FIG. 8, may be used to implement the described functionality in various aspects; for example, software components running on a variety of different devices and servers may collaborate to provide the functionality. In some aspects, portions of the described functionality may be implemented using storage devices, network devices or special-purpose computer systems, in addition to or instead of being implemented using general-purpose computer systems. The term “computing device,” as used herein, refers to at least all these types of devices and is not limited to these types of devices.

It should also be appreciated that the systems in the figures are merely illustrative and that other implementations might be used. Additionally, it should be appreciated that the functionality disclosed herein might be implemented in software, hardware, or a combination of software and hardware. Other implementations should be apparent to those skilled in the art. It should also be appreciated that a server, gateway, or other computing node may include any combination of hardware or software that may interact and perform the described types of functionality, including without limitation desktop or other computers, database servers, network storage devices and other network devices, PDAs, tablets, cellphones, wireless phones, pagers, electronic organizers, Internet appliances, and various other consumer products that include appropriate communication capabilities. In addition, the functionality provided by the illustrated modules may in some aspects be combined in fewer modules or distributed in additional modules. Similarly, in some aspects the functionality of some of the illustrated modules may not be provided and/or other additional functionality may be available.

Each of the operations, processes, methods, and algorithms described in the preceding sections may be embodied in, and fully or partially automated by, code modules executed by at least one computer or computer processors. The code modules may be stored on any type of non-transitory computer-readable medium or computer storage device, such as hard drives, solid state memory, optical disc, and/or the like. The processes and algorithms may be implemented partially or wholly in application-specific circuitry. The results of the disclosed processes and process steps may be stored, persistently or otherwise, in any type of non-transitory computer storage such as, e.g., volatile or non-volatile storage.

The various features and processes described above may be used independently of one another, or may be combined in various ways. All possible combinations and sub-combinations are intended to fall within the scope of this disclosure. In addition, certain method or process blocks may be omitted in some implementations. The methods and processes described herein are also not limited to any particular sequence, and the blocks or states relating thereto may be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed example aspects. The example systems and components described herein may be configured differently than described. For example, elements may be added to, removed from, or rearranged compared to the disclosed example aspects.

It will also be appreciated that various items are illustrated as being stored in memory or on storage while being used, and that these items or portions of thereof may be transferred between memory and other storage devices for purposes of memory management and data integrity. Alternatively, in other aspects some or all of the software modules and/or systems may execute in memory on another device and communicate with the illustrated computing systems via inter-computer communication. Furthermore, in some aspects, some or all of the systems and/or modules may be implemented or provided in other ways, such as at least partially in firmware and/or hardware, including, but not limited to, at least one application-specific integrated circuits (ASICs), standard integrated circuits, controllers (e.g., by executing appropriate instructions, and including microcontrollers and/or embedded controllers), field-programmable gate arrays (FPGAs), complex programmable logic devices (CPLDs), etc. Some or all of the modules, systems and data structures may also be stored (e.g., as software instructions or structured data) on a computer-readable medium, such as a hard disk, a memory, a network, or a portable media article to be read by an appropriate drive or via an appropriate connection. The systems, modules, and data structures may also be transmitted as generated data signals (e.g., as part of a carrier wave or other analog or digital propagated signal) on a variety of computer-readable transmission media, including wireless-based and wired/cable-based media, and may take a variety of forms (e.g., as part of a single or multiplexed analog signal, or as multiple discrete digital packets or frames). Such computer program products may also take other forms in other aspects. Accordingly, the disclosure may be practiced with other computer system configurations.

Conditional language used herein, such as, among others, “may,” “could,” “might,” “may,” “e.g.,” and the like, unless specifically stated otherwise, or otherwise understood within the context as used, is generally intended to convey that certain aspects include, while other aspects do not include, certain features, elements, and/or steps. Thus, such conditional language is not generally intended to imply that features, elements, and/or steps are in any way required for at least one aspects or that at least one aspects necessarily include logic for deciding, with or without author input or prompting, whether these features, elements, and/or steps are included or are to be performed in any particular aspect. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

While certain example aspects have been described, these aspects have been presented by way of example only, and are not intended to limit the scope of aspects disclosed herein. Thus, nothing in the foregoing description is intended to imply that any particular feature, characteristic, step, module, or block is necessary or indispensable. Indeed, the novel methods and systems described herein may be embodied in a variety of other forms; furthermore, various omissions, substitutions, and changes in the form of the methods and systems described herein may be made without departing from the spirit of aspects disclosed herein. The accompanying claims and their equivalents are intended to cover such forms or modifications as would fall within the scope and spirit of certain aspects disclosed herein.

The preceding detailed description is merely exemplary in nature and is not intended to limit the disclosure or the application and uses of the disclosure. The described aspects are not limited to use in conjunction with a particular type of machine. Hence, although the present disclosure, for convenience of explanation, depicts and describes particular machine, it will be appreciated that the assembly and electronic system in accordance with this disclosure may be implemented in various other configurations and may be used in other types of machines. Furthermore, there is no intention to be bound by any theory presented in the preceding background or detailed description. It is also understood that the illustrations may include exaggerated dimensions to better illustrate the referenced items shown, and are not consider limiting unless expressly stated as such.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

The disclosure may include communication channels that may be any type of wired or wireless electronic communications network, such as, e.g., a wired/wireless local area network (LAN), a wired/wireless personal area network (PAN), a wired/wireless home area network (HAN), a wired/wireless wide area network (WAN), a campus network, a metropolitan network, an enterprise private network, a virtual private network (VPN), an internetwork, a backbone network (BBN), a global area network (GAN), the Internet, an intranet, an extranet, an overlay network, a cellular telephone network, a Personal Communications Service (PCS), using known protocols such as the Global System for Mobile Communications (GSM), CDMA (Code-Division Multiple Access), Long Term Evolution (LTE), W-CDMA (Wideband Code-Division Multiple Access), Wireless Fidelity (Wi-Fi), Bluetooth, and/or the like, and/or a combination of two or more thereof.

Additionally, the various aspects of the disclosure may be implemented in a non-generic computer implementation. Moreover, the various aspects of the disclosure set forth herein improve the functioning of the system as is apparent from the disclosure hereof. Furthermore, the various aspects of the disclosure involve computer hardware that it specifically programmed to solve the complex problem addressed by the disclosure. Accordingly, the various aspects of the disclosure improve the functioning of the system overall in its specific implementation to perform the process set forth by the disclosure and as defined by the claims.

Recitation of ranges of values herein are merely intended to serve as a shorthand method of referring individually to each separate value falling within the range, unless otherwise indicated herein, and each separate value is incorporated into the specification as if it were individually recited herein. All methods described herein may be performed in any suitable order unless otherwise indicated herein or otherwise clearly contradicted by context.

We claim:

1. A method comprising:
receiving, via one or more computing devices, first data comprising information relating to an extraction of material at one or more mine sites and a transport of the material to one or more delivery sites external to the one or more mine sites;
receiving, via one or more computing devices, second data comprising market data relating to the material, the market data comprising a quantity of the material;
determining, via one or more computing devices, an optimization plan based at least on the first data and the second data, the optimization plan comprising a modification to at least one of the extraction of the material at the one or more mine sites and the transport of the material to the one or more delivery sites; and
generating, via one or more computing devices, an instruction based at least on the determined optimization plan comprising a modification to at least one of the following: the extraction of the material at the one or more mine sites and the transport of the material to the one or more delivery sites.

2. The method of claim 1, wherein the optimization plan comprises:
selecting a mine site from the one or more mine sites to produce the material; and
selecting a transport route connecting the selected mine site to the one or more delivery sites.

3. The method of claim 1, wherein the market data further comprises a commodity price of the material.

4. The method of claim 1, wherein the market data further comprises a purchase price of the material, a delivery time of the material, and a delivery location of the material.

5. The method of claim 1, wherein the determination of the optimization plan to modify the transport of the material to the one or more delivery sites is based at least on at least one of the following: a transport time, a transport price, a transport distance, and a transport means.

6. The method of claim 1, wherein the modification to the extraction of the material at the one or more mine sites comprises at least one of a modification to a strip ratio, a modification to a hauling route, a modification to an extraction rate, and a modification to a blast-hole pattern spacing.

7. The method of claim 1, further comprising:
updating the first data based on the optimization plan.

8. A system comprising:
a processor; and
a memory bearing instructions that, upon execution by the processor, cause the system at least to:
receive first data comprising information relating to an extraction of material at one or more mine sites and a transport of the material to one or more delivery sites external to the one or more mine sites;
receive second data comprising market data relating to the material, the market data comprising a quantity of the material;
determine an optimization plan based at least on the first data and the second data, the optimization plan comprising a modification to at least one of the extraction of the material at the one or more mine sites and the transport of the material to the one or more delivery sites; and
generate, based at least on the determined optimization plan, an instruction comprising a modification to at least one of the extraction of the material at the one or more mine sites and the transport of the material to the one or more delivery sites.

9. The system of claim 8, wherein the optimization plan comprises:
selecting a mine site from the one or more mine sites to produce the material; and
selecting a transport route connecting the selected mine site to the one or more delivery sites.

10. The system of claim 8, wherein the market data further comprises a commodity price of the material.

11. The system of claim 8, wherein the market data further comprises a purchase price of the material, a delivery time of the material, and a delivery location of the material.

12. The system of claim 8, wherein the determination of the optimization plan to modify the transport of the material to the one or more delivery sites is based at least on at least one of the following: a transport time, a transport price, a transport distance, and a transport means.

13. The system of claim 8, wherein the modification to the extraction of the material at the one or more mine sites comprises at least one of a modification to a strip ratio, a modification to a hauling route, a modification to an extraction rate, and a modification to a blast-hole pattern spacing.

14. The system of claim 8, further comprising:
update the first data based on the optimization plan.

15. A computer readable storage medium bearing instructions that, upon execution by a processor, effectuate operations comprising:
receiving, via one or more computing devices, first data comprising information relating to an extraction of material at one or more mine sites and a transport of the material to one or more delivery sites external to the one or more mine sites;
receiving, via one or more computing devices, second data comprising market data relating to the material, the market data comprising a quantity of the material;
determining, via one or more computing devices, an optimization plan based at least on the first data and the second data, the optimization plan comprising a modification to at least one of: the extraction of the material at the one or more mine sites and the transport of the material to the one or more delivery sites; and
generating, via one or more computing devices, an instruction based at least on the determined optimization plan comprising a directive relating to at least one of the following: the extraction of the material at the one or more mine sites and the transport of the material to the one or more delivery sites.

16. The computer readable storage medium of claim 15, wherein the optimization plan comprises:
selecting a mine site from the one or more mine sites to produce the material; and
selecting a transport route connecting the selected mine site to the one or more delivery sites.

17. The computer readable storage medium of claim 15, wherein the market data further comprises a commodity price of the material.

18. The computer readable storage medium of claim 15, wherein the market data further comprises a purchase price of the material, a delivery time of the material, and a delivery location of the material.

19. The computer readable storage medium of claim 15, wherein the determination of the optimization plan to modify the transport of the material to the one or more delivery sites is based at least on at least one of the following: a transport time, a transport price, a transport distance, and a transport means.

20. The computer readable storage medium of claim 15, wherein the modification to the extraction of the material at the one or more mine sites comprises at least one of a modification to a strip ratio, a modification to a hauling route, a modification to an extraction rate, and a modification to a blast-hole pattern spacing.
